(19) United States
(12) Patent Application Publication
(10) Pub. No.: US 2008/0110337 A1
(43) Pub. Date: May 15, 2008

(54) CARTRIDGE LIFE TESTER

(75) Inventors: Fred W. Hoffman, Columbia Station, OH (US); Leonard A. Quinn, Lagrange, OH (US); Randall W. Nichols, Westlake, OH (US); David J. Taneyhill, Grafton, OH (US); Justin R. Miller, Elyria, OH (US)

Correspondence Address: CALFEE HALTER & GRISWOLD, LLP, 800 SUPERIOR AVENUE, SUITE 1400, CLEVELAND, OH, 44114, US

(73) Assignee: Bendix Commercial Vehicle Systems LLC, Elyria, OH (US)

(21) Appl. No.: 11/558,234

(22) Filed: Nov. 9, 2006

(51) Int. Cl. B01D 53/32; B01D 53/30

(52) U.S. Cl. 95/3; 96/26; 95/10; 96/117.5

(57) ABSTRACT

A saturation level of moisture and/or other contaminants is determined in a desiccant material by determining an electrical parameter across the desiccant material. An air dryer includes a housing, a desiccant in the housing, and an electrical contact in the desiccant. A level of at least one of moisture and other contaminants is determined as a function of an electrical parameter between two electrical contacts of dissimilar materials that electrically contact the desiccant. Alternatively, the level of at least one of moisture and other contaminants is determined as a function of an amount of the reflected light received by the optical sensor from the desiccant.

### BACKGROUND

The present invention relates to desiccant cartridges. It finds particular application in conjunction with identifying when the desiccant within the cartridge is contaminated to a point where the cartridge including the desiccant should be replaced and will be described with particular reference thereto. It will be appreciated, however, that the invention is also amenable to other applications.

Air dryers are used in compressed air braking systems of, for example, heavy vehicles, to filter water and contaminants out of the compressed air. One way that dryer and cleaner compressed air contributes to improved performance of the braking system is by reducing failure of valves in colder weather as a result of icing.

One type of air dryer uses a desiccant material contained in a cartridge to filter the water and contaminants from the compressed air. The desiccant has a finite life. More specifically, over time, the desiccant becomes sufficiently contaminated and the performance degrades to a point that the cartridge must be replaced.

The present invention provides a new and improved apparatus and method for determining when the desiccant cartridge must be replaced.

### SUMMARY

In one aspect of the present invention, it is contemplated to determine a saturation level of moisture and/or other contaminants in a desiccant material by determining an electrical parameter across the desiccant material.

In one embodiment, an air dryer includes a housing, a desiccant in the housing, and an electrical contact in the desiccant. A level of at least one of moisture and other contaminants is determined as a function of an electrical parameter between two electrical contacts of dissimilar materials that electrically contact the desiccant.

In another embodiment, an air dryer includes a housing, a desiccant in the housing, and an optical sensor receiving reflected light from the desiccant. A level of at least one of moisture and other contaminants is determined as a function of an amount of the reflected light received by the optical sensor from the desiccant.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a schematic representation of an air dryer including aspects of a desiccant cartridge in accordance with one embodiment of an apparatus illustrating principles of the present invention;

FIG. 2 illustrates a schematic representation of a desiccant cartridge in accordance with a second embodiment of an apparatus illustrating principles of the present invention;

FIG. 3 illustrates a schematic representation of a desiccant cartridge in accordance with a third embodiment of an apparatus illustrating principles of the present invention;

FIG. 4 illustrates a schematic representation of a desiccant cartridge in accordance with a fourth embodiment of an apparatus illustrating principles of the present invention; and

FIG. 5 illustrates a schematic representation of a desiccant cartridge in accordance with a fifth embodiment of an apparatus illustrating principles of the present invention.

### DETAILED DESCRIPTION OF ILLUSTRATED EMBODIMENT

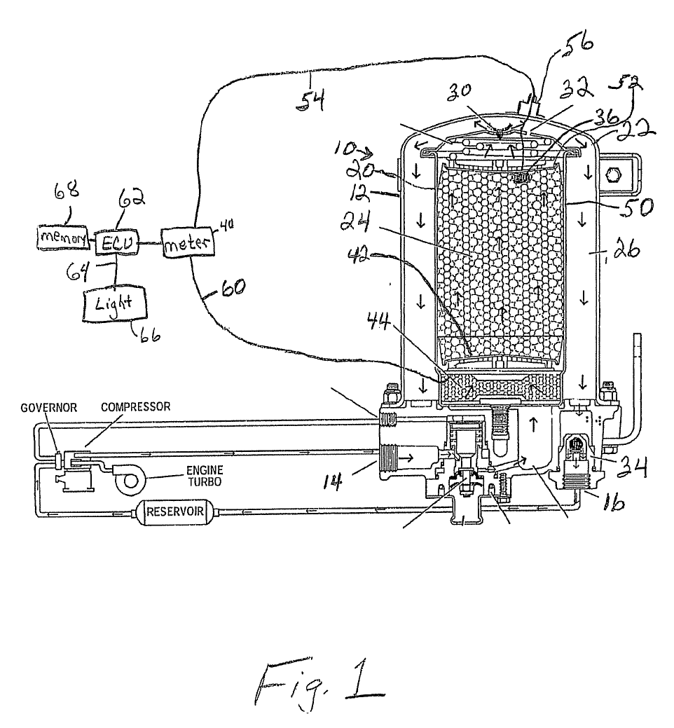

With reference to FIG. 1, an exemplary air dryer 10 is illustrated in accordance with one embodiment of the present invention. The air dryer includes a housing 12, a supply port 14, a delivery port 16, and a desiccant cartridge 20. The supply port 14 receives compressed air from an external source and provides the compressed air to an interior volume 22 of the housing 12. The delivery port 16 delivers the compressed air from the interior volume 22 to an exterior of the air dryer 10. In the illustrated embodiment, the cartridge 20 is removable from the housing 12. Therefore, the desiccant cartridge 20 may be relatively easily replaced with a new cartridge when, for example, the original cartridge is contaminated with moisture and/or other contaminants above a predetermined level.

The cartridge 20 encloses a desiccant material 24. During a charging cycle of the dryer 10, the compressed air enters the dryer 10 through the supply port 14. The compressed air is then communicated into the interior volume 22 of the housing 12 by first entering the desiccant cartridge 20. While in the cartridge 20, the compressed air passes through the desiccant material 24 as shown by the arrows. The air is cleaned and dried as it passes through the desiccant material 24. For example, moisture and/or other contaminants (e.g., oil) are trapped in the desiccant cartridge 20 by the desiccant material 24. The air is then communicated from the desiccant cartridge 20 into a purge volume 26 in the housing 12 via a check valve 30 and an orifice 32. The cleaned and dried air passes through the purge volume 26 and then exits the housing 12 and the dryer 10 via a check valve 34 and the delivery port 16. Over time, as more compressed air is cleaned and dried by the desiccant material 24, the desiccant material 24 in the desiccant cartridge 20 becomes contaminated with oil and, therefore, must be replaced.

A first electrical component 36 (e.g., an electrical contact) is in the desiccant material 24. The electrical contact 36 is electrically connected to a threshold measuring device such as a meter 40, which measures an electrical parameter of the contact 36. In one embodiment, the meter 40 is a comparator. Alternatively, the meter 40 represents an analog input to an ECU 62 that responds to the analog input.

In one embodiment, the electrical contact 36 includes an anode. It is to be understood that the anode 36 is in the desiccant material 24. A second electrical component 42 (e.g., a cathode) also electrically contacts the desiccant material 24. In one embodiment, the anode 36 and the cathode 42 are dissimilar materials (e.g., metals).

When dissimilar metals are immersed in an electrolyte, a voltage potential is self generated between the two materials. The magnitude of the electric potential is proportional to the electronegativity difference of the two materials.

Materials of particular usefulness to the automotive industry include:

| | |
|---|---|
| Magnesium | 1.31 |
| Aluminum | 1.61 |
| Zinc | 1.65 |
| Iron | 1.83 |
| Copper | 1.90 |
| Nickel | 1.91 |
| Tin | 1.96 |
| Lead | 2.33 |
| Carbon | 2.55 |

Magnesium is particularly advantageous for use with other metals because it generates a larger and more easily detected electrical potential. The theoretical voltage between a magnesium anode and a carbon cathode is 2.55−1.31=1.24 Volts. However, even the voltage between magnesium and zinc is 1.65−1.31=0.34 Volts is of useful magnitude for detecting desiccant wetness. Furthermore, magnesium acts as a sacrificial anode and protects metals with greater electronegativity from corrosion by the same mechanism that zinc protects galvanized iron. A battery effect will only work if there is a conductive electrolyte between an anode and a cathode. The desiccant material 24, when wet, serves as an electrolyte. Therefore, a battery effect is present (and electricity is generated) only if the desiccant material 24 is not dry.

The desiccant material 24 becomes wet as the moisture and/or other contaminants are removed from the compressed air. Furthermore, the wetness of the desiccant material 24 is proportional to a level of the moisture and/or other contaminants trapped in the desiccant material 24.

The material of the air dryer 10 housing 12 is non-conductive (e.g., non-conduction painted steel). The desiccant cartridge 20 includes a base portion 44 (e.g., a zinc coated steel plate or a crushed aluminum oil separator), which acts as the cathode 42. The base portion 44 is not in electrical contact with a wall 50 of the desiccant cartridge 20. Therefore, in one embodiment in which the anode 36 is a magnesium button fastened to an upper plastic perforated plate 52 in the cartridge 20, a battery effect is created between the magnesium anode 36 and the cathode 42. The meter 40 is electrically connected to the anode 36 and the cathode 42 for measuring an electrical parameter between the anode 36 and the cathode 42. In one embodiment, the electrical parameter is a voltage differential between the anode 36 and the cathode 42. Furthermore, the voltage differential between the anode 36 and the cathode 42 changes as a function of the level of moisture and/or other contaminants in the desiccant material 24. For example, the voltage differential between the anode 36 and the cathode 42 increases as the level of moisture and/or other contaminants in the desiccant material 24 increases.

A wire 54 (electrical conductor) is electrically and removably connected between the meter 40 and the anode 36. The wire 54 exits the housing 12 of the air dryer 10 via a fitting 56. Another wire 60 (electrical conductor) is electrically and removably connected between the cathode 42 and the meter 40. In this configuration, the meter 40 is electrically connected to both the cathode 42 and the anode 36. The meter 40 detects the voltage differential between the cathode 42 and the anode 36.

In one embodiment, the meter 40 electrically communicates with the electronic control module 62 (ECU). The ECU 62 monitors the electrical parameter (e.g., the voltage differential between the anode 36 and the cathode 42). The ECU 62 also communicates a signal indicating the level of moisture and other contaminants in the desiccant material 24 over a communication line 64 (e.g., a J1939 communication line on a heavy vehicle). In order to indicate a level of saturation of the desiccant material 24, a dash light 66 illuminates once the amount of the moisture and/or other contaminants exceeds a predetermined level. It is also contemplated that the ECU 62 communicates raw data of the meter readings to a memory device 68 so that historical data of the level of moisture and other contaminants in the desiccant material 24 is available to be analyzed.

Once it is determined that the level of moisture and other contaminants in the desiccant material 24 is above a predetermined level, the anode 36 and the cathode 42 are electrically disconnected from the wires 54, 60. Then, the desiccant cartridge 20 is removed from the housing 12 and replaced with a new cartridge including desiccant that is less saturated. The new desiccant cartridge is then electrically connected to the anode 36 and the cathode 42 via the wires 54, 60.

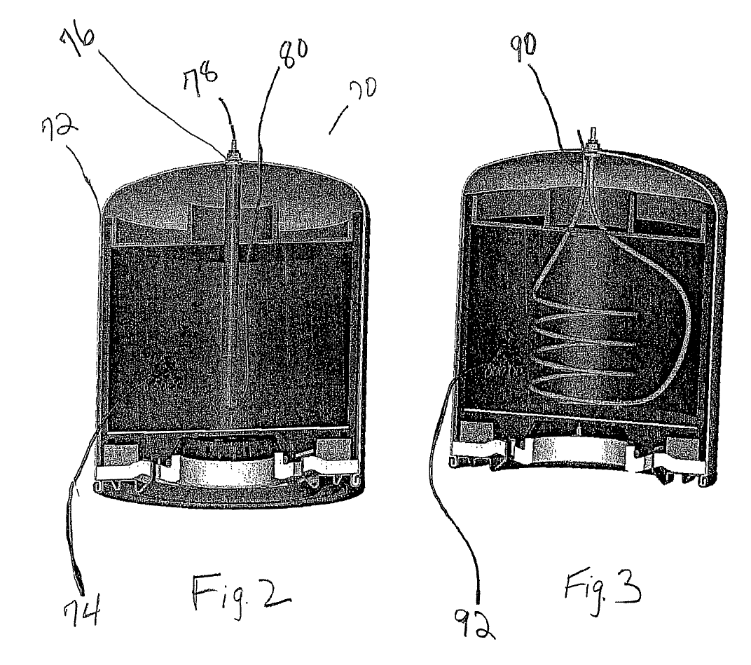

FIG. 2 illustrates another exemplary embodiment of the present invention. In this embodiment, the air dryer 70 includes a housing 72 that contains the desiccant material 74. However, there is not a removable desiccant cartridge, which contains the desiccant material 74, within the housing 72. Therefore, once it is determined that the desiccant material 74 is saturated above a predetermined level with moisture and/or other contaminants, the entire housing 72 is replaced. Although the embodiment illustrated in FIG. 1 illustrates a removable desiccant cartridge within the housing and the embodiment illustrated in FIG. 2 illustrates the desiccant material enclosed within a disposable housing, it is to be understood that a removable desiccant cartridge and the disposable housing may be used in either embodiment.

With reference to FIG. 2, an electrical contact 76 includes a probe (e.g., an electrically conductive element) having two terminals 78, 80 extending to the outside of the housing 72. Although it is not illustrated, it is to be understood that, like the embodiment illustrated in FIG. 1, a meter and/or an ECU are electrically connected to the terminals 78, 80 for measuring the electrical parameter of the contact 76. In this embodiment, the ECU and/or meter causes a current to be supplied to the contact 76. The current causes a resistance to be established in the contact 76, and the resistance is the electrical parameter determined by the ECU or meter. However, it is to be understood that other methods of determining resistance are also contemplated. Similar to the embodiment illustrated in FIG. 1, the resistance changes as a function of the level of moisture and/or other contaminants in the desiccant material 74. For example, the resistance of the contact 76 changes as the level of moisture and/or other contaminants in the desiccant material 74 changes.

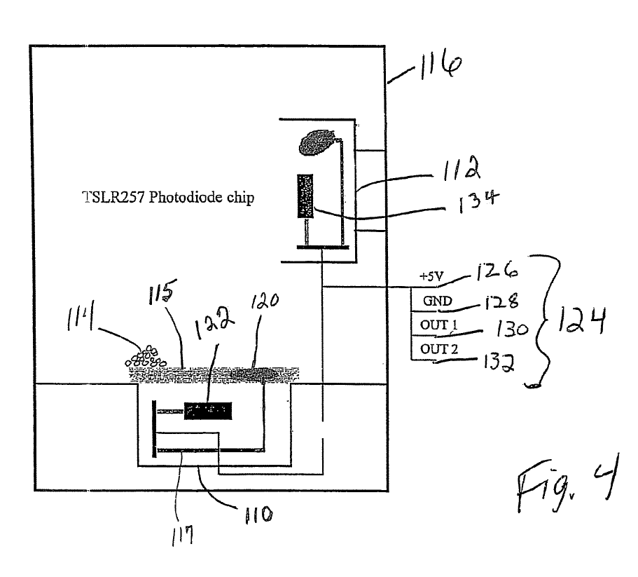

FIG. 3 illustrates another exemplary embodiment of the present invention. With reference to FIG. 3, the probe 90 is illustrated as a coil in the desiccant material 92. As in the embodiment shown in FIG. 2, the resistance of the coil probe 90 shown in FIG. 3 is the electrical parameter determined by the meter.

FIG. 4 illustrates another exemplary embodiment of the present invention. In this embodiment, first and second electrical components 110, 112, respectively, (optical sensor devices) are mounted in the desiccant material 114 inside the desiccant cartridge 116 and measure light reflected from the desiccant 114. In the illustrated embodiment, the first optical sensor 110 is positioned substantially vertical in the desiccant 114 and the second optical sensor 112 is positioned substantially horizontal in the desiccant 114. Both of the sensor devices 110, 112 include similar components and, therefore, only the first optical sensor 110 will be described in detail.

In one embodiment, the first optical sensor 110 includes a light source 120 (e.g., a light emitting diode (LED)) and a light detector 122 (e.g., a photodiode or photocell) electrically connected by a connector 117. It is contemplated that the light source 120 is a colored (e.g., red) LED. However, other embodiments including light sources of any other color are also contemplated. An optional window 115 provides an external view of the LED 120 (e.g., to confirm the LED is functioning). The light source 120 directs light onto the desiccant 114 and the detector 122 receives the light from the source 120 that is reflected by the desiccant 114. The amount of light reflected by the desiccant 114 is indicative of the contamination of the desiccant 114. For example, as the desiccant 114 becomes more contaminated, less of the light from the source 120 is reflected to the detector 122. The detector 122 changes an electrical parameter such as voltage as a function of the reflected light received from the desiccant 114. In addition to, or instead of, monitoring voltage, other parameters that may be monitored include current, inductance, capacitance, conductance, or digital signals. For example, the optical sensor 110 acts as a light-to-voltage sensor that produces a relatively higher voltage when the desiccant 114 is not contaminated and relatively lower voltage when the desiccant 114 is contaminated. An electrical connector 124 on the cartridge 116 provides a pin 126 for supplying power for illuminating the light source 120, a pin 128 electrically connected to ground, and a pin 130 electrically connected to the detector 122. The pin 130 transmits the voltage output by the detector 122 to an electrical measuring device (not shown) (e.g., a meter). A pin 132 is electrically connected to a detector 134 of the second optical sensor 112.

In another embodiment, it is contemplated that the first optical sensor 110 is an integrated circuit chip (e.g., the TAOS chip TRS1722).

Although two optical sensors 110, 112 are illustrated in the desiccant material 114, it is to be understood that any number of optical sensors (e.g., one (1) optical sensor or more than two (2) optical sensors) are contemplated.

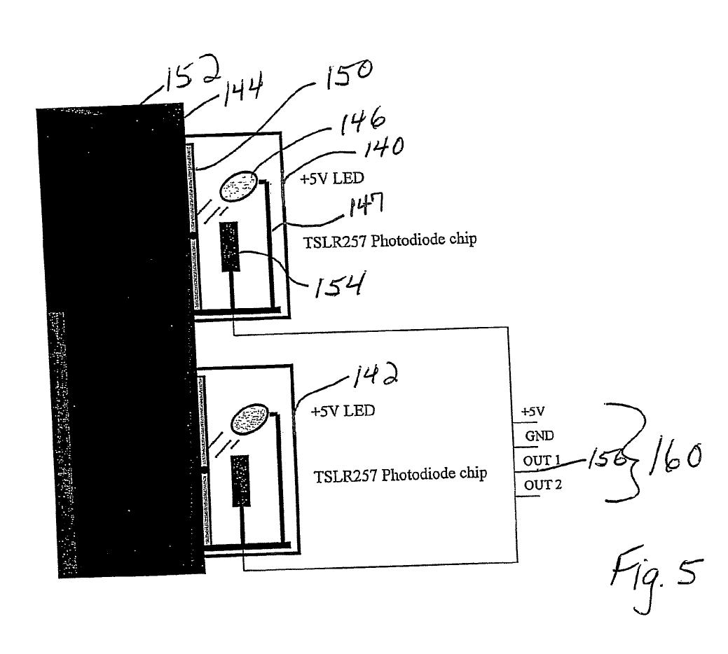

FIG. 5 illustrates another exemplary embodiment of the present invention. In this embodiment, first and second optical sensor devices 140, 142, respectively, are mounted external to the desiccant cartridge 144. The light from the source 146 (e.g., LED) is transmitted through a window 150 in the cartridge 144 and is reflected by the desiccant 152 in the cartridge 144. The reflected light is transmitted back through the window 150 to the detector 154. As in the embodiment illustrated in FIG. 4, the amount of light reflected by the desiccant 152 is indicative of the contamination of the desiccant 152. Furthermore, as discussed with reference to the embodiment in FIG. 4, the detector 154 produces a voltage as a function of the reflected light received from the desiccant 152. The voltage produced by the detector 154, which is electrically connected to the source 146 via connector 147, is measured at the pin 156 of the connector 160. As discussed above with reference to the embodiment illustrated in FIG. 4, it is to be understood that any number of optical sensor devices are contemplated for the embodiment illustrated in FIG. 5.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. An air dryer, comprising:
a housing;
a desiccant in the housing;
an electrical component for determining a level of at least one of moisture and other contaminants as a function of an electrical parameter.

2. The air dryer as set forth in claim 1, wherein the electrical component includes:
an electrical contact in the desiccant; and
a second electrical contact, the first and second electrical contacts including two dissimilar materials, a level of at least one of moisture and other contaminants being determined as a function of an electrical parameter between the first and second electrical contacts.

3. The air dryer as set forth in claim 1, wherein the electrical component includes:
an optical sensor receiving reflected light from the desiccant, a level of at least one of moisture and other contaminants being determined as a function of an amount of the reflected light received by the optical sensor.

4. The air dryer as set forth in claim 1, wherein the electrical parameter is one of voltage, current, inductance, capacitance, conductance, and digital signals.

5. An air dryer, comprising:
a housing;
a desiccant in the housing;
an electrical contact in the desiccant; and
a second electrical contact, the first and second electrical contacts including two dissimilar materials, a level of at least one of moisture and other contaminants being determined as a function of a voltage differential between the first and second electrical contacts.

6. The air dryer as set forth in claim 5, wherein the electrical contact includes an anode in the desiccant.

7. The air dryer as set forth in claim 5, wherein the first and second electrical contacts include two dissimilar metals.

8. The air dryer as set forth in claim 7, wherein:
the first electrical contact includes an anode; and
the second electrical contact includes a cathode.

9. The air dryer as set forth in claim 8, wherein:
the anode includes magnesium; and
the cathode includes steel.

10. The air dryer as set forth in claim 8, wherein the cathode is a zinc coated steel plate that electrically contacts the housing.

11. The air dryer as set forth in claim 5, wherein:
the electrical contact is a continuous electrically conductive element in the desiccant; and
the level of the at least one of moisture and other contaminants is determined as a function of an electrical resistance of the conductive element.

12. The air dryer as set forth in claim 1 1, wherein the contact includes two electrically conductive elements outside of the housing.

13. A system for determining a level of at least one of moisture and contaminants in a desiccant material within an air dryer, the system comprising:
an air dryer, including:
a housing;
a desiccant cartridge in the housing, the cartridge including desiccant material;
an electrical contact in the desiccant material; and
a second electrical contact contacting the desiccant material, the first electrical contact being an anode, the second electrical contact being a cathode, and the anode and the cathode including dissimilar metals, a level of at least one of moisture and other contaminants being determined as a function of a voltage difference between the electrical contacts; and
a meter, electrically connected to the electrical contacts, for measuring and indicating the voltage difference.

14. The system for determining a level of at least one of moisture and contaminants in a desiccant material within an air dryer as set forth in claim 13, wherein the voltage difference changes as the level of at least one of moisture and other contaminants changes.

15. The system for determining a level of at least one of moisture and contaminants in a desiccant material within an air dryer as set forth in claim 13, wherein the anode is magnesium.

16. The system for determining a level of at least one of moisture and contaminants in a desiccant material within an air dryer as set forth in claim 13, wherein the first electrical contact is a coil.

17. The system for determining a level of at least one of moisture and contaminants in a desiccant material within an air dryer as set forth in claim 13, wherein the first electrical contact is removably secured to the meter.

18. A method for replacing a desiccant cartridge as a function of a level of at least one of moisture and contaminants in the desiccant, the method comprising:
determining a level of at least one of the moisture and the other contaminants in the desiccant as a function of a voltage difference across the desiccant; and
replacing the desiccant cartridge as a function of the level of the voltage difference.

19. The method for determining a level of at least one of moisture and contaminants in desiccant within a cartridge as set forth in claim 18, further including:
electrically connecting a first electrical contact in the desiccant to a meter; and
electrically connecting a second electrical contact, which contacts the desiccant, to the meter.

20. The method for determining a level of at least one of moisture and contaminants in desiccant within a cartridge as set forth in claim 19, wherein if the voltage difference is above a predetermined level:
electrically disconnecting the first contact from the meter; and
electrically connecting the meter to a first contact positioned in a new desiccant cartridge.

21. The method for determining a level of at least one of moisture and contaminants in desiccant within a cartridge as set forth in claim 20, further including:
displaying the voltage difference.

22. The method for determining a level of at least one of moisture and contaminants in desiccant within a cartridge as set forth in claim 18, further including:
determining the voltage difference as a resistance between the electrical contacts.

23. A desiccant cartridge, comprising:
a cartridge housing;
desiccant in the cartridge housing; and
means for determining a level of at least one of moisture and other contaminants in the desiccant.

24. The desiccant cartridge as set forth in claim 23, wherein the means for determining includes:
an electrical contact in the desiccant.

25. The desiccant cartridge as set forth in claim 24, wherein the means for determining also includes:
a threshold measuring device for measuring a resistance of the contact.

26. The desiccant cartridge as set forth in claim 24, wherein the contact includes an electrical probe in the desiccant.

27. The desiccant cartridge as set forth in claim 24, wherein the contact includes:
an anode in the desiccant; and
a cathode electrically contacting both the desiccant and the cartridge housing.

28. The desiccant cartridge as set forth in claim 27, wherein the means for determining also includes:
a meter for measuring a voltage between the anode and the cathode.

29. The desiccant cartridge as set forth in claim 27, wherein:
the anode is magnesium; and
the cathode is zinc coated steel.

30. The desiccant cartridge as set forth in claim 23, wherein the means for determining includes:
an optical sensor.

31. A desiccant cartridge, comprising:
a cartridge housing;
desiccant in the cartridge housing;
an electrical anode in the desiccant; and
an electrical cathode in contact with the desiccant, a level of at least one of moisture and other contaminants being determined as a function of an electrical voltage between the anode and the cathode.

32. The desiccant cartridge as set forth in claim 31, further comprising:
electrical conductors connected to the anode and cathode, respectively, that electrically and removably connect with a meter for measuring the voltage.

33. The desiccant cartridge as set forth in claim 31, wherein:
the anode and the cathode are dissimilar metals.

34. A desiccant cartridge, comprising:
a cartridge housing;
desiccant in the cartridge housing;
an electrical probe in the desiccant, a level of at least one of moisture and other contaminants being determined as a function of an electrical resistance in the probe.

35. The desiccant cartridge as set forth in claim 34, wherein:
the probe is a coil in the desiccant.

36. An air dryer, comprising:
a housing;
a desiccant in the housing; and
an optical sensor receiving reflected light from the desiccant, a level of at least one of moisture and other contaminants being determined as a function of an amount of the reflected light received by the optical sensor.

37. The air dryer as set forth in claim 36, wherein the optical sensor includes:
a light source for transmitting light to the desiccant; and
a detector receiving the reflected light, a voltage being produced by the detector as a function of the amount of the reflected light received by the detector.

38. The air dryer as set forth in claim 37, wherein:
the light source is a light emitting diode; and
the detector is a photodiode.

39. The air dryer as set forth in claim 36, wherein the optical sensor is in the desiccant.

40. The air dryer as set forth in claim 36, wherein the optical sensor is external to the housing.
